(19) United States
(12) Patent Application Publication
(10) Pub. No.: US 2014/0341031 A1
(43) Pub. Date: Nov. 20, 2014

(54) DIFFERENTIATION OF TRAFFIC FLOWS MAPPED TO THE SAME BEARER

(71) Applicant: Nokia Corporation, Espoo (FI)

(72) Inventor: Jari Mutikainen, Lepsama (FI)

(73) Assignee: Nokia Corporation, Espoo (FI)

(21) Appl. No.: 14/271,045

(22) Filed: May 6, 2014

Related U.S. Application Data
(60) Provisional application No. 61/825,231, filed on May 20, 2013.

(51) Int. Cl. H04W 28/02; H04L 12/851

(52) U.S. Cl. CPC H04W 28/0263; H04L 47/2441; H04W 28/0236
USPC 370/235

(57) ABSTRACT

In accordance with an example embodiment of the present invention, an apparatus comprising: at least one processor; and at least one memory including computer program code, wherein the at least one memory and the computer program code are configured to, with the at least one processor, cause the apparatus to perform at least the following: receive at least one traffic flow; establish at least one bearer for communication; assign a first quality of service class identifier value associated with the at least one bearer; map the at least one traffic flow to the at least one bearer; and determine a second quality of service class identifier value for a data packet of the at least one traffic flow.

### TECHNICAL FIELD

The present application relates generally to wireless communications and, more specifically, differentiation of traffic flows mapped to the same bearer for downlink transmission.

### BACKGROUND

Quality of service (QoS) provides access network operators and service operators with a set of tools to enable service and subscriber differentiation. Such tools are becoming increasingly important as operators are moving from a single to a multi-service offering at the same time as both the number of mobile broadband subscribers and the traffic volume per subscriber is rapidly increasing.

Bearer is the enabler for traffic separation, it provides differential treatment for traffic with differing QoS requirements. The bearer is the level of granularity for bearer-level QoS control. That is, all packet flows mapped to the same bearer receive the same packet-forwarding treatment. The packet-forwarding treatment comprises, for example, scheduling policy and queue management policy. Providing different packet-forwarding treatment requires separate bearers. QoS is class-based, where each bearer is assigned one and only one QoS class identifier (QCI) by the network. The QCI is a scalar that is used within the access network as a reference to node-specific parameters that control packet forwarding treatment.

### SUMMARY

Various aspects of examples of the invention are set out in the claims.

According to a first aspect of the present invention, an apparatus comprising: at least one processor; and at least one memory including computer program code, wherein the at least one memory and the computer program code are configured to, with the at least one processor, cause the apparatus to perform at least the following: receive at least one traffic flow; establish at least one bearer for communication; assign a first quality of service class identifier value associated with the at least one bearer; map the at least one traffic flow to the at least one bearer; and determine a second quality of service class identifier value for a data packet of the at least one traffic flow.

According to a second aspect of the present invention, a method comprising: receiving at least one traffic flow; establishing at least one bearer for communication; assigning a first quality of service class identifier value associated with the at least one bearer; mapping the at least one traffic flow to the at least one bearer; and determining a second quality of service class identifier value for a data packet of the at least one traffic flow.

According to a third aspect of the present invention, a computer program product comprising a computer-readable medium bearing computer program code embodied therein for use with a computer, the computer program code comprising: code for receiving at least one traffic flow; code for establishing at least one bearer for communication; code for assigning a first quality of service class identifier value associated with the at least one bearer; code for mapping the at least one traffic flow to the at least one bearer; and code for determining a second quality of service class identifier value for a data packet of the at least one traffic flow.

According to a fourth aspect of the present invention, an apparatus comprising: at least one processor; and at least one memory including computer program code, wherein the at least one memory and the computer program code are configured to, with the at least one processor, cause the apparatus to perform at least the following: establish at least one bearer for communication; receive a first quality of service class identifier value associated with the at least one bearer; receive at least one traffic flow carried over the at least one bearer; determine a second quality of service class identifier value for a data packet of the at least one traffic flow; and schedule data packet for transmission based at least in part on the second quality of service class identifier value.

According to a fifth aspect of the present invention, an apparatus comprising: means for receiving at least one traffic flow; means for establishing at least one bearer for communication; means for assigning a first quality of service class identifier value associated with the at least one bearer; means for mapping the at least one traffic flow to the at least one bearer; and means for determining a second quality of service class identifier value for a data packet of the at least one traffic flow.

According to a sixth aspect of the present invention, an apparatus comprising: means for establishing at least one bearer for communication; means for receiving a first quality of service class identifier value associated with the at least one bearer; means for receiving at least one traffic flow carried over the at least one bearer; means for determining a second quality of service class identifier value for a data packet of the at least one traffic flow; and means for scheduling data packet for transmission based at least in part on the second quality of service class identifier value.

### BRIEF DESCRIPTION OF THE DRAWINGS

For a more complete understanding of example embodiments of the present invention, reference is now made to the following descriptions taken in connection with the accompanying drawings in which:

FIG. 1 depicts an example of a network in which some embodiments of the present invention may be practiced;

FIG. 2 depicts an example implementation of traffic flow differentiation in accordance with some embodiments of the invention;

FIG. 3 depicts an example process for traffic flow differentiation at core network in accordance with some embodiments of the invention;

FIG. 4 depicts an example process for traffic flow differentiation at a base station in accordance with some embodiments of the invention;

FIG. 5 illustrates an example implementation of a base station in accordance with some embodiments of the invention; and

FIG. 6 illustrates an example implementation of a core network node in accordance with some embodiments of the invention.

### DETAILED DESCRIPTION OF THE DRAWINGS

Radio access network (RAN) user plane congestion occurs when the demand for RAN resources exceeds the available RAN capacity to deliver the user data for a period of time. For example, when a UE opens a single web page, tens of new traffic flows may be created. Some of the traffic flows may have different QoS requirements. When the network creates a bearer, or updates an existing bearer, the UE is updated via Non-access stratum (NAS) and radio resource control (RRC) signaling a QCI value and a Traffic Flow Template (TFT) of the bearer. QCI is a parameter that controls packet forwarding treatment. TFT indicates to the UE the 5-tuples of the traffic flows assigned to the bearer. The 5-tuples include source and destination IP address, source and destination port number, and protocol ID. Since each bearer is assigned one and only one QCI and TFT, when the network creates multiple bearers for the traffic flows that require different QCI and TFT, the amounts of NAS/RRC signaling may cause congestion in RAN. RAN user plane congestion leads, for example, to packet drops or delays, and may result in degraded end-user experience.

The subject matter disclosed herein provides a way for the network to improve the end user perceived service quality in RAN congestion situations, by traffic flow identification and prioritization. Specifically, there is provided a way of assigning a QCI value to each of the traffic flows mapped to the same bearer—allowing the network to prioritize the packet data transmission without creating multiple bearers, therefore reduces the radio resource control signaling, which is associated with creating and maintaining multiple bearers, over the radio interface.

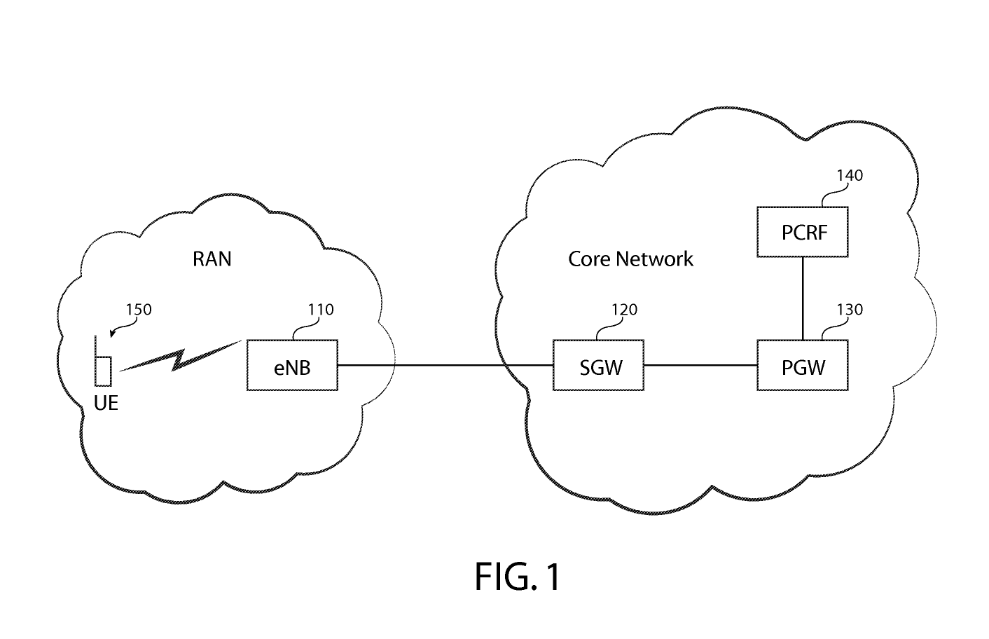

FIG. 1 illustrates an example of a network in which some example embodiments of the present invention may be practiced. As illustrated in FIG. 1, the User Equipment (UE) 150 is connected to the core network through an Evolved NodeB (eNB) 110 via Radio Access Network (RAN). It is noted that eNB 110 may be any type of control or base station. In some example embodiments, the core network may comprise network elements such as the Serving Gateway (SGW) 120, the PDN Gateway (PGW) 130, and the Policy and Charging Rules Function (PCRF) 140. The gateways, for example, the SGW 120 and the PGW 130, deal with the user plane data transfer. They transport the IP data traffic between the UE 150 and the external networks. The SGW 120 is the point of interconnect between RAN and core network. This gateway serves the UE 150 by routing the incoming and outgoing IP packets. It is logically connected to the other gateway, for example, the PGW 130. The PGW 130 is the point of interconnect between the core network and the external packet data networks. The PGW 130 routes packets to and from the external packet data networks. The PDN GW 130 also performs various functions such as policy enforcement, packet filtering for each UE, charging support, lawful interception and packet screening. PCRF 140 is a software node designated in real-time to determine policy rules for each UE. PCRF 140 supports the detection of service data flow, the charging system based on this data flow, and policy enforcement. Quality of service (QoS) rules and regulations are distributed to the PGW 130 by the PCRF 140.

It is noted that the network elements are for illustration purpose, some of the network elements, for example, SGW and PGW, may be SGSN and GGSN in Global System for Mobile communications (GSM) and 3G networks. It is also noted that these gateways may be physically separated or they may be combined into single equipment.

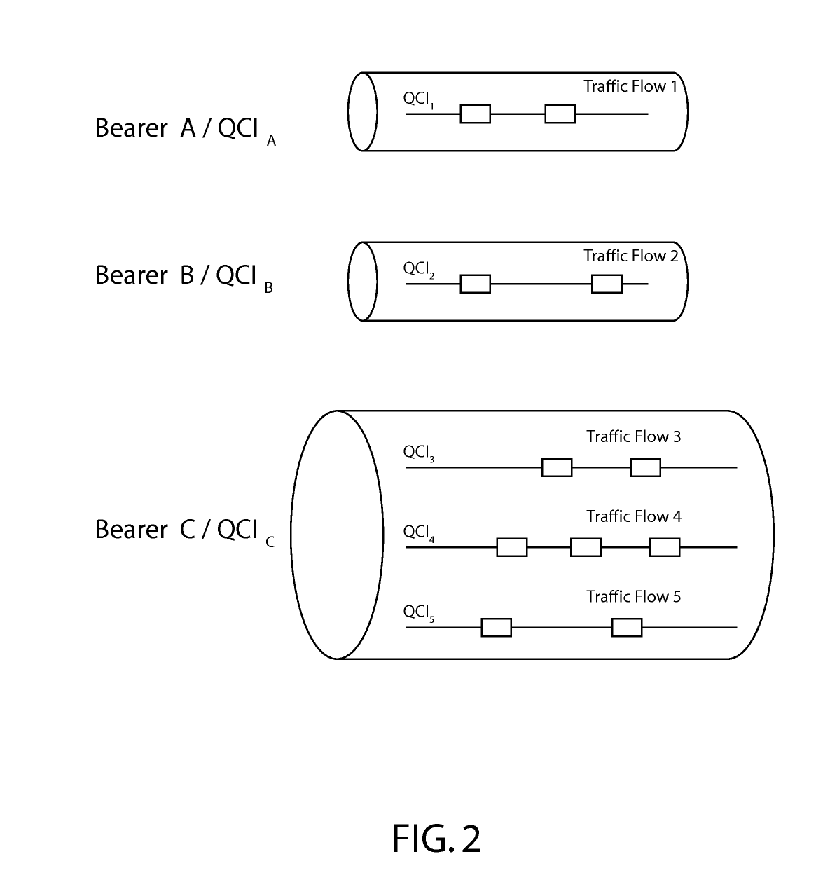

FIG. 2 depicts an example implementation of traffic flow differentiation in accordance with some embodiments of the invention.

QCI is a scalar that is used within the access network as a reference to node-specific parameters that control packet forwarding treatment. Each QCI value is associated with standardized QCI characteristics. The characteristics describe the packet forwarding treatment that the bearer traffic receives edge-to-edge between the UE and the gateway in terms of resource type, priority, packet delay budget, packet error loss rate. For example, reference can be made to 3GPP TS 23.203 V11.9.0 (2013-03) 3rd Generation Partnership Project; Technical Specification Group Services and System Aspects; Policy and charging control architecture (Release 11). The one-to-one mapping of QCI values to standardized QCI characteristics in the reference is illustrated in Table 1.

TABLE 1
Standardized QCI characteristics

| | | | | Packet | |
|---|---|---|---|---|---|
| | | | Packet | Error | |
| | | | Delay | Loss | |
| | Resource | | Budget | Rate | |
| QCI | Type | Priority | (NOTE 1) | (NOTE 2) | Example Services |
| 1 | GBR | 2 | 100 ms | 10⁻² | Conversational Voice |
| (NOTE 3) | | | | | |
| 2 | | 4 | 150 ms | 10⁻³ | Conversational Video (Live Streaming) |
| (NOTE 3) | | | | | |
| 3 | | 3 | 50 ms | 10⁻³ | Real Time Gaming |
| (NOTE 3) | | | | | |
| 4 | | 5 | 300 ms | 10⁻⁶ | Non-Conversational Video (Buffered Streaming) |
| (NOTE 3) | | | | | |
| 5 | Non-GBR | 1 | 100 ms | 10⁻⁶ | IMS Signalling |
| (NOTE 3) | | | | | |
| 6 | | 6 | 300 ms | 10⁻⁶ | Video (Buffered Streaming) |
| (NOTE 4) | | | | | TCP-based (e.g., www, e-mail, chat, ftp, p2p file |
| | | | | | sharing, progressive video, etc.) |
| 7 | | 7 | 100 ms | 10⁻³ | Voice, |
| (NOTE 3) | | | | | Video (Live Streaming) |
| | | | | | Interactive Gaming |
| 8 | | 8 | 300 ms | 10⁻⁶ | Video (Buffered Streaming) |
| (NOTE 5) | | | | | TCP-based (e.g., www, e-mail, chat, ftp, p2p file |
| | | | | | sharing, progressive video, etc.) |
| 9 | | 9 | | | |
| (NOTE 6) | | | | | |

In some example embodiments, a gateway, for example, PGW 130, performs downlink packet filtering to map the traffic flows onto the intended bearer. As illustrated in FIG. 2, bearer A is assigned a bearer level QCI_{A}, bearer B is assigned a bearer level QCI_{B}, and bearer C is assigned a bearer level QCI_{C}. In some example embodiments, a gateway, for example, PGW 130, assigns data packets of the traffic flows with traffic flow level QCI. In some example embodiments, one traffic flow is mapped to one bearer. For example, traffic flow 1 is mapped to bearer A and the traffic flow level QCI is the same as bearer level QCI, that is, QCI₁=QCI_{A}. In some example embodiments, one or more traffic flows with different QoS requirements may be mapped to the same bearer. For example, three traffic flows are mapped to bearer C in FIG. 2. Traffic flow 3 may be live video streaming which has packet delay budget 100 ms and packet loss rate of 10⁻³, the data packets of traffic flow 3 are assigned a QCI value of 7 according to Table 1. Traffic flow 4 may be buffered video streaming which has packet delay budget 300 ms and packet loss rate of 10⁻⁶, the data packets of traffic flow 4 are assigned a QCI value of 8. Traffic flow 5 may be TCP-based p2p file sharing which has delay budget 300 ms and packet loss rate of 10⁻⁶, the data packets of traffic flow 5 are assigned a QCI value of 6.

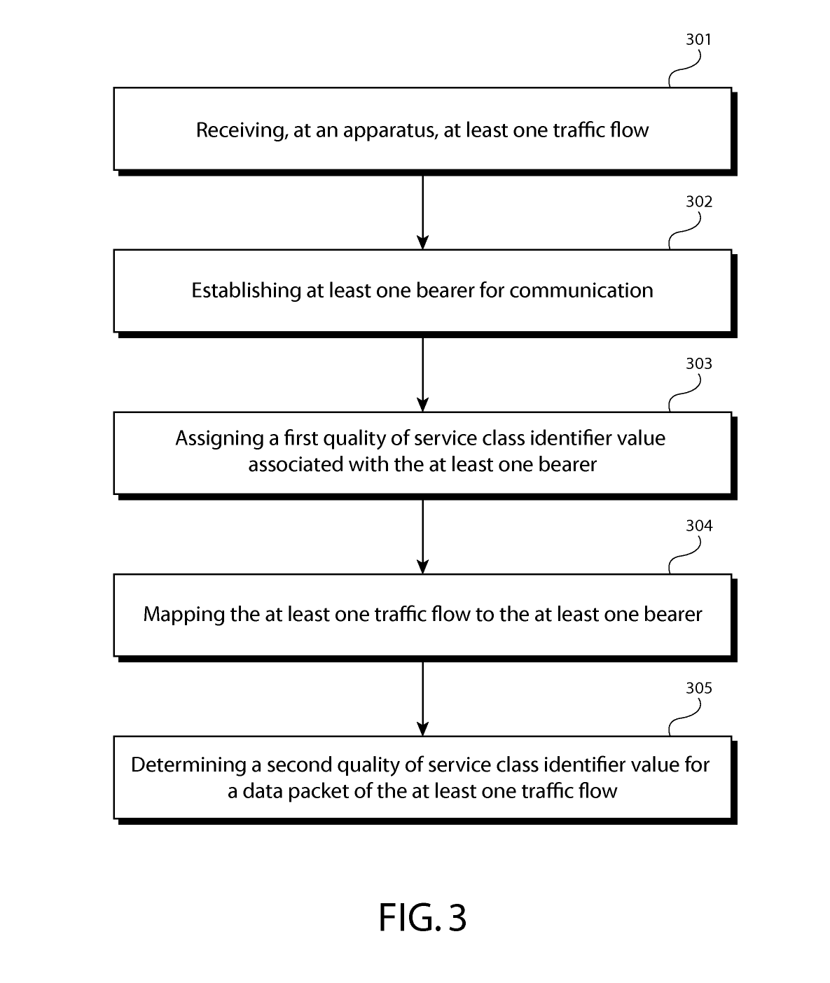

FIG. 3 depicts an example process for traffic flow differentiation at core network in accordance with some embodiments of the invention. In some example embodiments, the example process may be performed by or in an apparatus, such as PGW 130 or SGW 120. In some other example embodiments, the example process may be performed by or in a plurality of apparatus, such as PGW 130 and SGW 120.

At 301, the apparatus receives one or more traffic flows. For example, in FIG. 2, traffic flows 1-5 are received at the apparatus.

At 302, at least one bearer is established for communication. For example, in FIG. 2, bearers A-C are established for communication.

At 303, the apparatus assigns a first QCI value for the at least one established bearer, the first QCI value is the bearer level QCI. For example, in FIG. 2, the first QCI values for bearer A-C are QCI_{A}, QCI_{B}, and QCI_{C}, respectively.

At 304, the apparatus maps the one or more traffic flows to the at least one bearer. For example, in FIG. 2, traffic flow 1 is mapped to bearer A, traffic flow 2 is mapped to bearer B, and traffic flows 3-5 are mapped to bearer C.

At 305, the apparatus determines a second QCI value for data packets of the received traffic flows. The second QCI value is the traffic flow level QCI. The determination of second QCI value, for example, may be based on policies received from PCRF 140 and/or information collected after packet inspection of the data packets and/or user subscription. In some example embodiments, the packet inspection may be shallow packet inspection, deep packet inspection, or heuristic analysis. Referring to the example in FIG. 2, the second QCI values for data packets of traffic flow 1 is QCI₁, the second QCI values for data packets of traffic flow 2 mapped to bearer B is QCI₂, and the second QCI values for data packets of traffic flows 3-5 mapped to bearer C, are QCI₃-QCI₅, which have the value of 7, 8, 6, respectively in the given example.

In some example embodiments, the traffic flow level QCI is assigned to all data packets for transmission. In some other example embodiments, the traffic flow level QCI for each data packets is assigned on need basis. For example, if traffic flow level QCI is the same as the bearer level QCI, then traffic flow level QCI is not assigned to the data packets for the traffic flow to save transmission bandwidth. The receiving node may use the bearer level QCI to determine the traffic level QCI. If the traffic level QCI value differs from the bearer level QCI value, then the traffic level QCI value is assigned to the data packets for transmission.

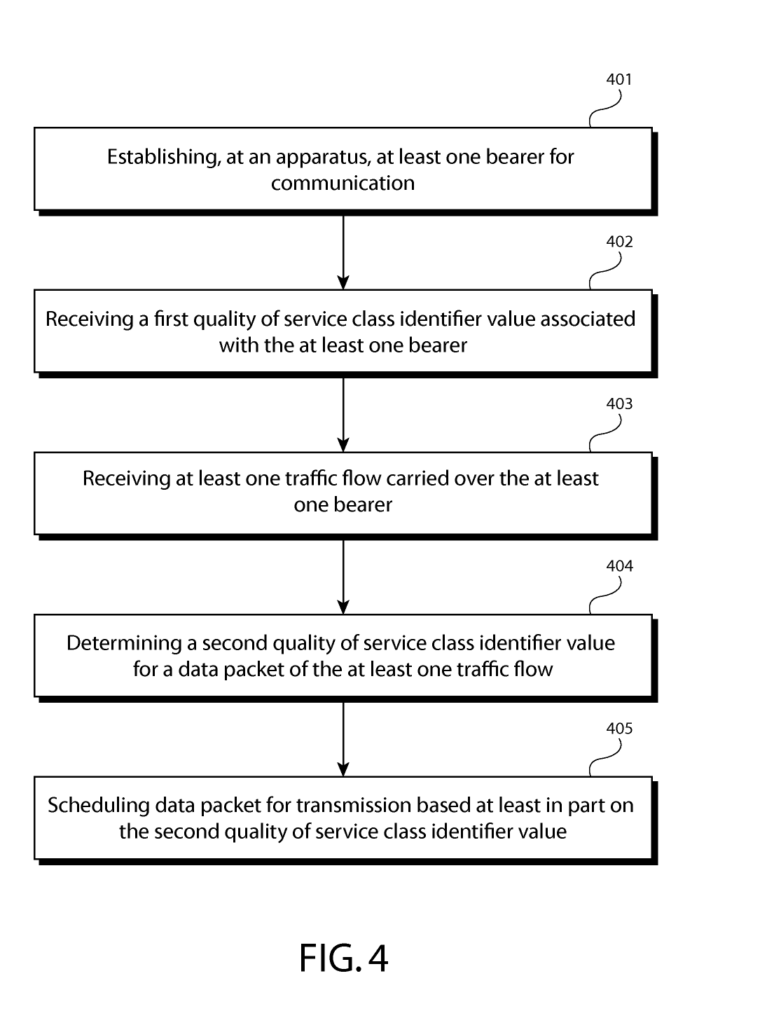

FIG. 4 depicts an example process for traffic flow differentiation at a base station in accordance with some embodiments of the invention. The example process may be performed by or in an apparatus, such as eNB 110.

At 401, at least one bearer is established for communication. For example, in FIG. 2, bearers A-C are established for communication.

At 402, the apparatus receives a first quality of service class identifier value associated with the at least one bearer. The first QCI value is the bearer level QCI. For example, in FIG. 2, the first QCI values for bearer A-C are QCI_{A}, QCI_{B}, and QCI_{C}, respectively.

At 403, the apparatus receives at least one traffic flow carried over the at least one bearer. For example, in FIG. 2, traffic flow 1 is carried over bearer A, traffic flow 2 is carried over bearer 2, and traffic flows 3-5 are carried over bearer C.

At 404, the apparatus determines a second quality of service class identifier value for a data packet of the at least one traffic flow. The second QCI value is the traffic flow level QCI. In some example embodiment, if a traffic level QCI value is assigned to the data packet, then the apparatus determines that the traffic level QCI value for the data packet is equal to the assigned traffic level QCI value. In some other example embodiments, if a traffic level QCI value is not assigned to the data packet, then the apparatus determines that the traffic level QCI value for the data packet is equal to the bearer level QCI value.

At 405, the apparatus schedules data packet for transmission based on the traffic level QCI value. When scheduling data packet transmission to a user equipment, the apparatus may give priority to data packets based on the traffic level QCI value. For example, in FIG. 2, if QCI₃=7 and QCI₅=6, the apparatus may give priority to data packets from traffic flow 5 in preference to data packets from traffic flow 3. If data packets from different traffic flows (may be from the same or different bearers) have the same QCI value, then the apparatus may have the same treatment with the data packets. For example, in FIG. 2, if QCI₁=QCI₃, the apparatus may use the same treatment with the data packets from traffic flow 1 and 3.

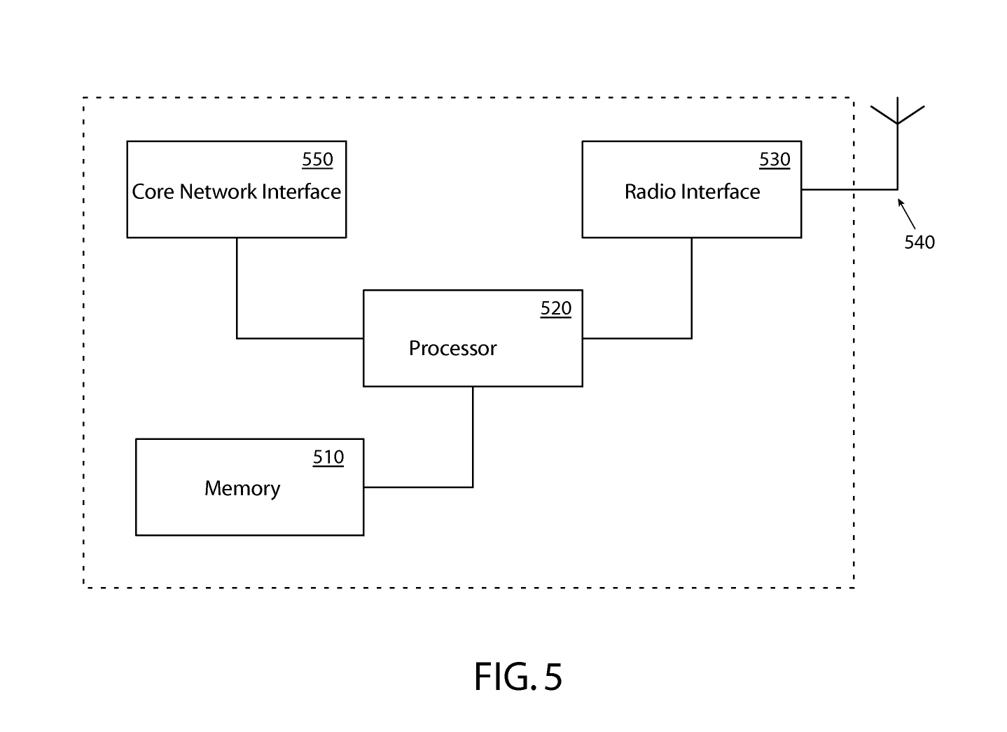

FIG. 5 depicts an example implementation of a base station in accordance with some embodiments of the invention, such as a base station eNB 110. The base station may include one or more antennas 540 configured to transmit via a downlink and configured to receive uplinks via the antenna(s). The base station may further include a plurality of radio interfaces 530 coupled to the antenna 540. The radio interfaces may correspond one or more of the following: Long Term Evolution (LTE, or E-UTRAN), Third Generation (3G, UTRAN, or high speed packet access (HSPA)), Global System for Mobile communications (GSM), wireless local area network (WLAN) technology, such as for example 802.11 WiFi and/or the like, Bluetooth, Bluetooth low energy (BT-LE), near field communications (NFC), and any other radio technologies. The radio interface 530 may further include other components, such as filters, converters (for example, digital-to-analog converters and the like), mappers, a Fast Fourier Transform (FFT) module, and the like, to generate symbols for a transmission via one or more downlinks and to receive symbols (for example, via an uplink). The base station may further include one or more core network interfaces 550, for receiving and transmitting to the core network. The base station may further include one or more processors, such as processor 520, for controlling the interfaces 530 and 550 and for accessing and executing program code stored in memory 510. In some example embodiments, the memory 510 includes code, which when executed by at least one processor causes one or more of the operations described herein with respect to a base station.

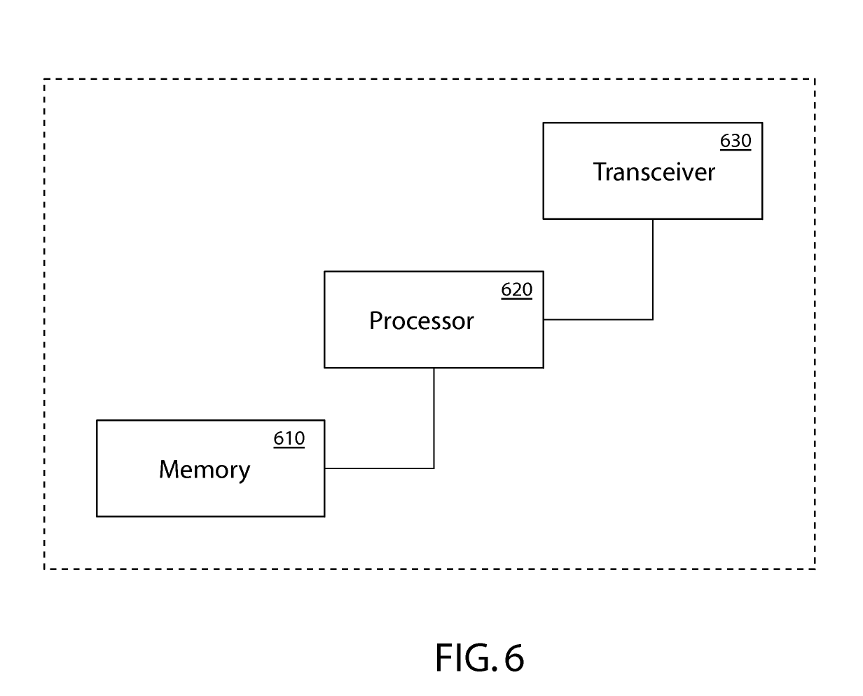

FIG. 6 depicts an example implementation of a core network node in accordance with some embodiments of the invention, such as SGW 120, PGW 130 or PCRF 140. The core network node may include a transceiver 630, for receiving and transmitting to a base station or another core network node or external networks. The core network node may further include one or more processors, such as processor 620, for controlling the transceiver 630 and for accessing and executing program code stored in memory 610. In some example embodiments, the memory 610 includes code, which when executed by at least one processor causes one or more of the operations described herein with respect to a core network node.

Without in any way limiting the scope, interpretation, or application of the claims appearing below, a technical effect of one or more of the example embodiments disclosed herein may include enabling traffic flow identification and prioritization to improve the user perceived service quality in radio network congestion situations.

Embodiments of the present invention may be implemented in software, hardware, application logic or a combination of software, hardware and application logic. The software, application logic and/or hardware may reside on memory 40 and/or 42, the control apparatus 20 or electronic components, for example. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted in FIG. 4 and FIG. 5. A computer-readable medium may comprise a computer-readable non-transitory storage medium that may be any media or means that can contain or store the instructions for use by or in connection with an instruction execution system, apparatus, or device, such as a computer. The scope of the present invention comprises computer programs configured to cause methods according to embodiments of the invention to be performed.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims. Other embodiments may be within the scope of the following claims. The term “based on” includes “based at least in part on”.

What is claimed is:

1. A method, comprising:
receiving, at an apparatus, at least one traffic flow;
establishing at least one bearer for communication;
assigning a first quality of service class identifier value associated with the at least one bearer;
mapping the at least one traffic flow to the at least one bearer; and
determining a second quality of service class identifier value for a data packet of the at least one traffic flow.

2. The method of claim 1, wherein determining a second quality of service class identifier value for a data packet of the at least one traffic flow is based at least in part on information associated with packet inspection.

3. The method of claim 1, wherein the first quality of service class identifier value is assigned based on the following characteristics associated with the bearer: resource type, priority, packet delay budget and packet error loss rate.

4. The method of claim 1, wherein the second quality of service class identifier value is determined based on the following characteristics associated with the data packet: resource type, priority, packet delay budget and packet error loss rate.

5. The method of claim 1, further comprising: assigning the second quality of service class identifier value to the data packet of the at least one traffic flow.

6. The method of claim 1, further comprising: if the first quality of service class identifier value is equal to the second quality of service class identifier value, then quality of service class identifier value is not assigned to the data packet; if the first quality of service class identifier value differs from the second quality of service class identifier value, then assigning the second quality of service class identifier value to the data packet.

7. An apparatus, comprising:
at least one processor; and
at least one memory including computer program code,
wherein the at least one memory and the computer program code are configured to, with the at least one processor, cause the apparatus to perform at least the following:
receive at least one traffic flow;
establish at least one bearer for communication;
assign a first quality of service class identifier value associated with the at least one bearer;
map the at least one traffic flow to the at least one bearer; and
determine a second quality of service class identifier value for a data packet of the at least one traffic flow.

8. The apparatus of claim 7, wherein determining a second quality of service class identifier value for a data packet of the at least one traffic flow is based at least in part on information associated with packet inspection.

9. The apparatus of claim 7, wherein the first quality of service class identifier value is assigned based on the following characteristics associated with the bearer: resource type, priority, packet delay budget and packet error loss rate.

10. The apparatus of claim 7, the second quality of service class identifier value is determined based on the following characteristics associated with the data packet: resource type, priority, packet delay budget and packet error loss rate.

11. The apparatus of claim 7, wherein the apparatus is caused to further perform: assign the second quality of service class identifier value to the data packet of the at least one traffic flow.

12. The apparatus of claim 7, wherein the apparatus is caused to further perform: if the first quality of service class identifier value is equal to the second quality of service class identifier value, then quality of service class identifier value is not assigned to the data packet; if the first quality of service class identifier value differs from the second quality of service class identifier value, then assigning the second quality of service class identifier value to the data packet.

13. An apparatus, comprising:
at least one processor; and
at least one memory including computer program code,
wherein the at least one memory and the computer program code are configured to, with the at least one processor, cause the apparatus to perform at least the following:
establish at least one bearer for communication;
receive a first quality of service class identifier value associated with the at least one bearer;
receive at least one traffic flow carried over the at least one bearer;
determine a second quality of service class identifier value for a data packet of the at least one traffic flow; and
schedule data packet for transmission based at least in part on the second quality of service class identifier value.

14. The apparatus of claim 13, wherein determining a second quality of service class identifier value for a data packet of the at least one traffic flow comprises: if quality of service class identifier value is not assigned to the data packet, then the second quality of service class identifier value is equal to the first quality of service class identifier value.

15. The apparatus of claim 13, wherein determining a second quality of service class identifier value for a data packet of the at least one traffic flow comprises: if a quality of service class identifier value is assigned to the data packet, then the second quality of service class identifier value is equal to the assigned quality of service class identifier value.

16. The apparatus of claim 13, wherein scheduling data packet for transmission comprises: prioritizing transmission for data packet based at least in part on the second quality of service class identifier value.
